(19) United States
(12) Patent Application Publication
(10) Pub. No.: US 2011/0121163 A1
(43) Pub. Date: May 26, 2011

(54) METHOD, APPARATUS AND COMPUTER-READABLE MEDIUM ESTIMATING ENERGY RESPONSE FUNCTION OF ENERGY RESOLVING X-RAY DETECTOR

(75) Inventors: Dong-Goo Kang, Suwon-si (KR); Jong Ha Lee, Hwaseong-si (KR); Young Hun Sung, Hwaseong-si (KR); Seong Deok Lee, Suwon-si (KR)

(73) Assignee: SAMSUNG ELECTRONICS CO., LTD., Suwon-si (KR)

(21) Appl. No.: 12/950,172

(22) Filed: Nov. 19, 2010

(30) Foreign Application Priority Data
Nov. 20, 2009 (KR) 10-2009-0112481

(51) Int. Cl. G01D 18/00

(52) U.S. Cl. 250/252.1; 378/207

(57) ABSTRACT

Disclosed are an energy response estimating apparatus, a method and computer-readable medium thereof that estimates an energy response function determined by a substance constituting a detector and physical parameters, and corrects multi-energy image information by using the estimated energy response function. The energy response estimating apparatus includes an emitting unit to emit multiple polychromatic X-rays having different energy levels to an object, a sensing unit to calculate a spectrum measurement value of a detector by counting photons from the multiple polychromatic X-rays that pass through the object, and an estimating unit to estimate an energy response function based on the calculated spectrum measurement value of the detector.

### CROSS-REFERENCE TO RELATED APPLICATIONS

This application claims the benefit of Korean Patent Application No. 10-2009-0112481, filed on Nov. 20, 2009, in the Korean Intellectual Property Office, the disclosure of which is incorporated herein by reference.

### BACKGROUND

1. Field

Example embodiments relate to an energy response function estimating method, apparatus and computer-readable medium storing a method that may estimate an energy response function of an X-ray detector and may correct multi-energy image information by using the estimated energy response function.

2. Description of the Related Art

An X-ray is an electromagnetic wave having a great penetrating ability, and includes a gamma ray and a ray corresponding to a medium wave length of an ultraviolet (UV) ray. An X-ray image may be generated based on a principle that a penetration ratio is changed responsive to a type of substance constituting the object and a thickness of the object. The X-ray image may be used in various fields, such as a medical field, a security checking field, a nondestructive testing field, and the like.

Estimation of an energy response function of an X-ray detector and correction based on the estimated energy response function of the X-ray detector may be desired to be performed to obtain an X-ray image of multi-energy by using an X-ray detector. A method includes obtaining several monochromatic responses by using a monochromatic X-ray source, and then estimating the energy response function of the X-ray detector by using a Medipix simulator.

### SUMMARY

The foregoing and/or other aspects are achieved by providing an energy response function estimating apparatus including an emitting unit to emit multiple polychromatic X-rays having different energy levels to an object, a sensing unit to calculate a spectrum measurement value of a detector by counting photons from the multiple polychromatic X-rays that pass through the object, and an estimating unit to estimate an energy response function based on the calculated spectrum measurement value of the detector.

The foregoing and/or other aspects are achieved by providing an energy response function estimating method including emitting multiple polychromatic X-rays having different energy levels to an object, calculating a spectrum measurement value of a detector by counting photons from the multiple polychromatic X-rays that pass through the object, initializing a tube voltage of an X-ray tube for the multiple polychromatic X-rays and calculating a real X-ray spectrum with respect to the initialized tube voltage, and estimating an energy response function based on the calculated spectrum measurement value of the detector.

The foregoing and/or other aspects are achieved by providing at least one computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating an energy response function estimating apparatus of an X-ray detector according to example embodiments;

FIG. 2 is a flowchart illustrating an energy response function estimating method of an X-ray detector according to example embodiments; and

FIG. 3 is a flowchart illustrating an energy response function estimating method that estimates an energy response function by applying a threshold scan according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

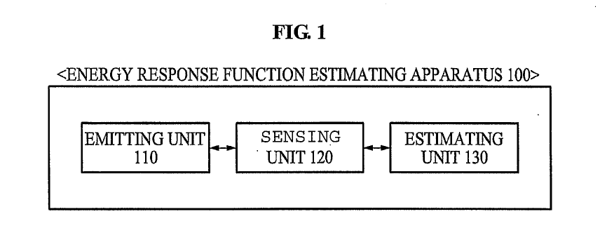

FIG. 1 illustrates an energy response function estimating apparatus 100 of an X-ray detector according to example embodiments.

The energy response function estimating apparatus 100 of the X-ray detector 100 may include an emitting unit 110, a sensing unit 120, and an estimating unit 130.

The energy response function estimating apparatus 100 of the X-ray detector may obtain a detector measurement with respect to various tube voltage spectra set (kVp spectra set) by using a polychromatic X-ray source, and at the same time, may obtain a real spectra measurement with respect to the kVp spectra set, thereby estimating an energy response function of the X-ray detector through applying an inverse estimation by simultaneously using the obtained measurement data.

Also, the energy response function estimating apparatus 100 of the X-ray detector may restore the real spectra measurement from a distorted measurement of the detector by using the estimated energy response function of the X-ray detector.

First, the emitting unit 110 may emit multiple polychromatic X-rays having different energy levels, to an object.

Also, according to example embodiments, the energy response function estimating apparatus 100 of the X-ray detector may obtain an X-ray image by using the multiple polychromatic X-rays having different energy levels. In this instance, an X-ray image obtained based on the described method may have a low contrast compared with an X-ray image obtained by using a monochromatic X-ray or a narrowband X-ray. However, the energy response function estimating apparatus 100 may obtain an X-ray image having a higher contrast, due to a layer of a scintillator panel, compared with an X-ray image apparatus using a single polychromatic X-ray. An energy level of a polychromatic X-ray may indicate an average energy of a polychromatic X-ray.

The emitting unit 110 according to example embodiments may sequentially emit multiple X-rays and the emitted X-rays may be in a form of a cone-beam or a fan-beam, for example.

The energy response function estimating apparatus 100 enables the multiple X-rays emitted by the emitting unit 110 to pass through an object (not shown in FIG. 1).

Next, the sensing unit 120 may count photons from the multiple polychromatic X-rays that pass through the object, thereby calculating a spectrum measurement value of the X-ray detector.

The X-ray detector specified throughout the present specification may be understood as an energy resolving X-ray detector (ERXD) that distinguishes energy of an X-ray photon based on a pixel unit to detect a signal and stores the detected signal, and becomes an image sensor when pixels are arranged in two-dimensions (2D).

As a detailed example, the X-ray detector disclosed in the present specification may be understood as a single photon counting X-ray detector (SPCXD), such as Medipix2.

The sensing unit 120 according to example embodiments may initialize a tube voltage (kVp) of an X-ray tube for the multiple polychromatic X-rays, and may calculate a real X-ray spectrum with respect to the tube voltage of the initialized tube.

The calculated real X-ray spectrum together with the measured spectrum measurement value of the X-ray detector may be used for estimating the energy response function.

The sensing unit 120 according to example embodiments may calculate a real X-ray spectrum by increasing the tube voltage by a predetermined amount from the initialized tube voltage.

The sensing unit 120 may perform a threshold scan with respect to the emitted multiple polychromatic X-rays to measure a spectrum of the detector.

To perform the threshold scan, the sensing unit 120 may sequentially change an energy threshold with respect to the tube voltage set for the X-ray tube.

Also, the sensing unit 120 may measure a spectrum of the detector corresponding to each energy threshold by using the sequentially changed energy threshold.

The sensing unit 120 may obtain multi-energy X-ray data from at least one energy threshold by using the threshold scan.

Also, the sensing unit 120 may measure the spectrum of the detector by using the obtained multi-energy X-ray data.

The sensing unit 120 may measure the spectrum of the detector by reconstructing a successive energy spectrum by using the obtained multi-energy X-ray data.

As a detailed example, the sensing unit 120 sets major parameters excluding the tube voltage, such as an mA, an exposure-time of an X-ray, and the like, as appropriate values, when initializing the tube voltage of the X-ray tube.

Accordingly, the sensing unit 120 may calculate the real X-ray spectrum with respect to the set tube voltage, by a spectrometer device.

In addition, the sensing unit 120 may perform the threshold scan to obtain the spectrum measurement value of the detector, the spectrum measurement value corresponding to the calculated real X-ray spectrum.

The threshold scan specified throughout the specification may be an operation of obtaining X-ray multi-energy data from an energy threshold. The sensing unit 120 according to example embodiments may reconstruct a successive energy spectrum by appropriately processing the obtained data.

That is, most single photon counting X-ray detectors (SPCXDs), such as Medipix2, may only have 2 to 6 energy threshold values, and thus, when the sensing unit 120 intends to calculate a spectrum, the sensing unit 120 may perform the threshold scan that obtains the data by sequentially changing an energy threshold with respect to a same X-ray tube set.

The sensing unit 120 may initialize a detector energy threshold of the detector for the threshold scan at a given tube voltage of a tube.

Subsequently, the sensing unit 120 may control the emitting unit 110, may perform an X-ray exposure process, may read a value stored in a counter of the detector, and may store the read value in a memory.

The sensing unit 120 may repeatedly perform the threshold scan with respect to all threshold set values required for constructing the spectrum.

Also, the sensing unit 120 may change a predetermined amount of a voltage from the initialized tube voltage, when a first instance of the threshold scan is finished, thereby proceeding with a next threshold.

An upper limit of the tube voltage according to example embodiments may be determined as a maximum value of an X-ray energy that is generally used for obtaining an image.

The estimating unit 130 according to example embodiments may estimate the energy response function based on the spectrum measurement value of the detector, the spectrum measurement value being calculated according to the threshold scan of the sensing unit 120.

In other words, the estimating unit 130 may estimate the energy response function based on the calculated spectrum measurement value of the detector and the real X-ray spectrum.

Particularly, the estimating unit 130 may estimate the energy response function by using an inverse estimation based on the real X-ray spectrum and the spectrum measurement value of the detector.

The estimating unit 130 may estimate the energy response function by applying the inverse estimation by using a distorted spectrum obtained through the threshold scan of the sensing unit 120 and a real spectrum at a spectrometer for each of a plurality of tube voltages.

The estimating unit 130 may repeatedly perform the described series of operations for measuring the energy response function with respect to each of pixels constituting the X-ray detector.

Hereinafter, an example embodiment in which the estimating unit 130 estimates the energy response function by applying the inverse estimation will be further described.

As a detailed example, the sensing unit 120 may calculate a real spectrum by setting a tube voltage from 30 to 110 kVp in 1 kVp intervals, and the real spectrum may be assumed to be S.

In this instance, when the spectrum reconstructed by the threshold scan is assumed to be N, a relationship between S and N are expressed as given in Equation 1.

$$[ \begin{matrix}{N}_{1} \\ {N}_{2} \\ {N}_{3} \\ ⋮ \\ {N}_{N}\end{matrix} ] = [ \begin{matrix}{R}_{1} ( {S}_{1} ) & {R}_{1} ( {S}_{2} ) & … & {R}_{1} ( {S}_{N} ) \\ {R}_{2} ( {S}_{1} ) & {R}_{2} ( {S}_{2} ) & … & {R}_{2} ( {S}_{N} ) \\ ⋮ & ⋮ & ⋮ & ⋮ \\ {R}_{N - 1} ( {S}_{1} ) & {R}_{N - 1} ( {S}_{2} ) & … & {R}_{N - 1} ( {S}_{N} ) \\ {R}_{N} ( {S}_{1} ) & {R}_{N} ( {S}_{2} ) & … & {R}_{N} ( {S}_{N} )\end{matrix} ] [ \begin{matrix}{S}_{1} \\ {S}_{2} \\ {S}_{3} \\ ⋮ \\ {S}_{N}\end{matrix} ] + [ \begin{matrix}{ɛ}_{1} \\ {ɛ}_{2} \\ {ɛ}_{3} \\ ⋮ \\ {ɛ}_{N}\end{matrix} ] \qquad [ Equation 1 ]$$

In this instance, Rn(Sn) indicates an element of matrix with respect to the energy response function, when M pairs of S and N are measured, Equation 2 may be obtained.

[N₁N₂ . . . N_{M}]=R[S₁S₂ . . . S_{M}]+[E₁E₂ . . . E_{M}]N_{N×M}=R_{N×N}S_{N×M}+E_{N×M} [Equation 2]

Accordingly, a method of calculating of R that minimizes E based on N and S that are obtained according to Equation 2 may be a general inverse estimation method.

When a spectrum of an incident X-ray is accurately known, a significantly clear image may be obtained, or a specific substance may be accentuated by using a unique attenuation feature of components constituting an object having been X-rayed. As an example, an X-ray image diagnostic device may have a highly improved ability of discriminating a normal/abnormal tissue of a patient, and an X-ray screening device at an airport may have an ability of detecting a dangerous substance, such as a liquid bomb and the like.

However, only a few measurement values may be obtained by a single X-ray exposure since the measurement value of the detector is distorted due to the energy response function, an ability of discriminating energy is limited, a number of energy discriminators in a photon counting pixel is limited, and a number of counters is limited.

However, theoretically, the real spectrum of the incident X-ray may be accurately predicted by using a same number of spectrum bins as a number of bases, when the energy response function of the detector is assumed to be known and a fact that a number of attenuation basis functions of the object is limited is recognized.

As an example, in a case of components of a human body, including water, fat, protein, bone, and the like are expressed as a decay function based on two bases including a photoelectric absorption and a Compton scattering. Thus, a continuous spectrum identical to an original spectra may be obtained by using a detector that is capable of separating two or more energies.

Accordingly, the energy response function estimating apparatus 100 of the X-ray detector according to example embodiments may solve difficulties in generating an ideal monochromatic source and may solve difficulties in estimating the energy response function due to an error.

Generally, an expensive device, such as an X-ray generating device using a beam of an accelerator and the like, may be separately needed to use a tunable X-ray source which is close to the monochromatic spectra.

The device is extremely expensive and a simulator that is accompanied by the device may not perfectly reproduce a real phenomenon, and thus, an accurate result may not be expected.

The energy response function estimating apparatus 100 of the X-ray detector according to example embodiments may solve a difficulty in responding to different types of detector, such as a hetero photoconductor substance, and a detector having different resolutions.

In addition, a quality assurance is desired by a medical image diagnostic device since the repetitive energy response function estimation is not possible due to the described difficulties, and the energy response function estimating apparatus 100 may conveniently and promptly process the quality assurance.

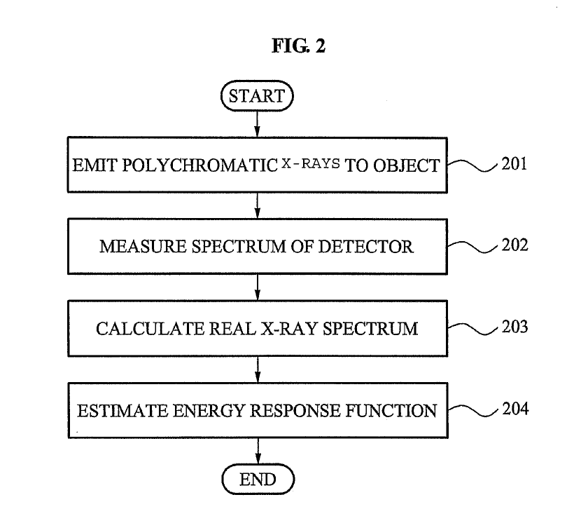

FIG. 2 is a flowchart illustrating an energy response function estimating method of an X-ray detector according to example embodiments.

In operation 201, the energy response function estimating method of the X-ray detector according to example embodiments emits multiple polychromatic X-rays having different energy levels, to an object.

In operation 202, the energy response function estimating method of the X-ray detector according to example embodiments counts photons from the emitted multiple polychromatic X-rays that pass through the object, thereby calculating a spectrum measurement value of the detector.

The energy response function estimating method of the X-ray detector according to example embodiments may perform a threshold scan with respect to the emitted multiple polychromatic X-rays and may measure a spectrum of the detector.

Particularly, the energy response function estimating method of the X-ray detector according to example embodiments may measure the spectrum of the detector by sequentially changing an energy threshold with respect to a tube voltage set for an X-ray tube, to calculate the spectrum measurement value of the detector.

In operation 203, the energy response function estimating method of the X-ray detector according to example embodiments initializes a voltage tube of an X-ray tube for the polychromatic X-rays, and may calculate a real X-ray spectrum with respect to the initialized tube voltage.

In operation 204, the energy response function estimating method of the X-ray detector according to example embodiments estimates the energy response function based on the calculated spectrum measurement value of the detector and the real X-ray spectrum.

The energy response function estimating method of the X-ray detector according to example embodiments may estimate the energy response function by performing an inverse estimation based on the real X-ray spectrum and the spectrum measurement value of the detector, to estimate the energy response function.

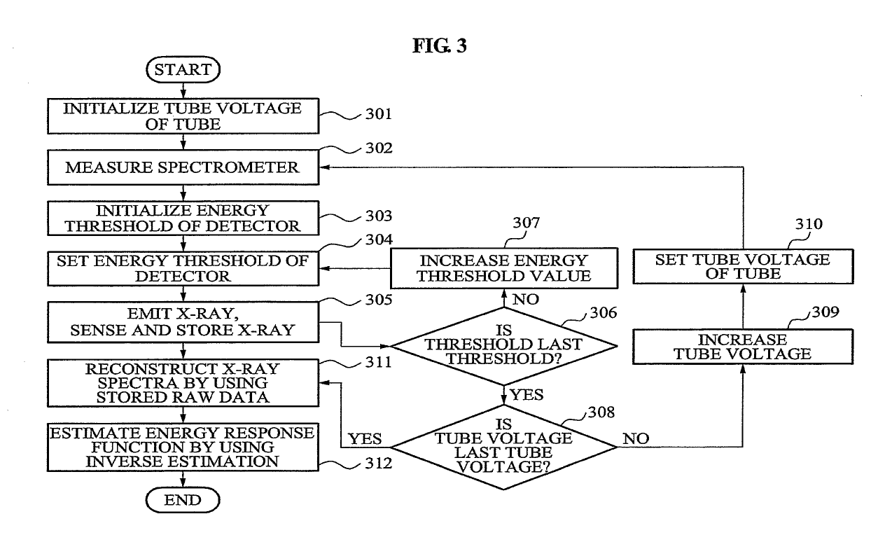

The energy response function estimating method of the X-ray detector according to example embodiments will be further described with reference to FIG. 3.

FIG. 3 is a flowchart illustrating an energy response function estimating method that estimates an energy response function by applying a threshold scan according to example embodiments.

First, the energy response function estimating method according to example embodiments initializes a tube voltage of an X-ray tube in operation 301.

The energy response function estimating method according to example embodiments may change the tube voltage and may perform a threshold scan. When major parameters excluding the tube voltage, such as an mA, an exposure-time of an X-ray, and the like may be set as appropriate values.

In operation 302, the energy response function estimating method according to example embodiments measures a real X-ray spectrum with respect to the set tube voltage, by using a spectrometer device.

In operation 303, the energy response function estimating method according to example embodiments initializes an energy threshold of the detector and finishes preparation for the threshold scan.

In operation 304, the energy response function estimating method according to example embodiments sets a system for the threshold scan with respect to the initialized energy threshold of the detector.

In operation 305, the energy response function estimating method according to example embodiments emits an X-ray for the threshold scan, and stores an X-ray sensed by the detector, the sensed X-ray corresponding to the emitted X-ray. Next, the energy response function estimating method according to example embodiments determines whether a current threshold is a last threshold in operation 306, and when the current threshold is not the last threshold, increases the energy threshold value in operation 307 and proceeds with operation 304 to prepare next threshold scan.

When the current threshold is the last threshold as a result of the determination in operation 306, the energy response function estimating method according to example embodiments further determines whether a current tube voltage is a last tube voltage in operation 308.

In this instance, when the current tube voltage is not the last tube voltage, the energy response function estimating method according to example embodiments may increase the tube voltage by a predetermined amount in operation 309, may set the increased tube voltage as the tube voltage 310, and may proceed with operation 302.

When the current tube voltage is the last tube voltage, the energy response function estimating method according to example embodiments may reconstruct a spectra of the X-ray by using raw data stored in a memory in operation 311. When the spectra of the X-ray is reconstructed, the energy response function estimating method according to example embodiments may estimate the energy response function by using an inverse estimation.

Next, when the energy response function is estimated, the estimated energy response function may be used for correcting an obtained X-ray image.

Therefore, the energy response function estimating method according to example embodiments may precisely estimate the energy response function indicating a spectrum distortion of the detector, thereby dramatically improving a picture quality of the X-ray image.

The energy response function estimating method according to example embodiments may estimate the energy response function, thereby enabling estimation of a real X-ray spectra and improving a performance of various multi-energy application, namely, an accuracy of the multi-energy application.

The energy response function estimating method according to example embodiments may easily estimate a distortion by using a polychromatic X-ray source that is already equipped, and thus, a quick and accurate estimation is possible at a low cost.

The method of estimating an energy response function of an X-ray detector according to the above-described example embodiments may also be implemented through computer readable code/instructions stored in/on a medium, e.g., a computer readable medium, to control at least one processing element to implement any above described embodiment. The medium can correspond to a non-transitory medium/media permitting the storing or transmission of the computer readable code. The computer readable medium may also be embodied in at least one application specific integrated circuit (ASIC) or Field Programmable Gate Array (FPGA).

The computer readable code can be recorded or transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored or transferred and executed in a distributed fashion. Still further, as only an example, the processing element could include at least one processor or at least one computer processor, and processing elements may be distributed or included in a single device.

In addition to the above described embodiments, example embodiments can also be implemented as hardware, e.g., at least one hardware based processing unit including at least one processor capable of implementing any above described embodiment. The described hardware devices may be configured to act as one or more software modules in order to perform the operations of the above-described exemplary embodiments, or vice-versa.

According to example embodiments, the energy response function estimating apparatus. method and computer-readable medium may conveniently estimate an energy response function without a separate X-ray source, or may effectively repeatedly estimate the energy response function as circumstances dictate.

Also, the energy response function estimating apparatus, method and computer-readable medium according to example embodiments may estimate a unique energy response function of the detector to correct an obtained X-ray image, thereby enabling a precise measurement.

In addition, the energy response function estimating apparatus, method and computer-readable medium according to example embodiments may accurately measure a result without using an expensive device.

The energy response function estimating method according to example embodiments may estimate the energy response function, thereby enabling estimation of a real X-ray spectra and improving a performance of various multi-energy application, namely, an accuracy of the multi-energy application.

The energy response function estimating method according to example embodiments may easily estimate a distortion by using a polychromatic X-ray source that is already equipped, and thus, a quick and accurate estimation is possible at a low cost.

Although a few embodiments have been shown and described, it should be appreciated by those skilled in the art that changes may be made in these embodiments without departing from the principles and spirit of the disclosure, the scope of which is defined by the claims and their equivalents.

What is claimed is:

1. An apparatus estimating an energy response function, the apparatus comprising:
an emitting unit to emit multiple polychromatic X-rays having different energy levels to an object;
a sensing unit to calculate a spectrum measurement value of a detector by counting photons from the multiple polychromatic X-rays that pass through the object; and
an estimating unit to estimate an energy response function based on the calculated spectrum measurement value of the detector.

2. The apparatus of claim 1, wherein the sensing unit initializes a tube voltage of an X-ray tube for the multiple polychromatic X-ray.

3. The apparatus of claim 2, wherein the sensing unit calculates a real X-ray spectrum with respect to the initialized tube voltage.

4. The apparatus of claim 3, wherein the estimating unit estimates the energy response function based on the calculated spectrum measurement value of the detector and the real X-ray spectrum.

5. The apparatus of claim 4, wherein the sensing unit performs a threshold scan with respect to the emitted multiple polychromatic X-rays and measures the spectrum of the detector.

6. The apparatus of claim 5, wherein the threshold scan measures the spectrum of the detector by sequentially changing an energy threshold with respect to the tube voltage set for the X-ray tube.

7. The apparatus of claim 5, wherein the sensing unit obtains multi-energy X-ray data from at least one energy threshold by performing the threshold scan, and measures the spectrum of the detector by using the obtained multi-energy X-ray data.

8. The apparatus of claim 5, wherein the sensing unit reconstructs a successive energy spectrum by using the obtained multi-energy X-ray data, and measures the spectrum of the detector.

9. The apparatus of claim 4, wherein the estimating unit estimates the energy response function by performing an inverse estimation based on the real X-ray spectrum and the spectrum measurement value of the detector.

10. A method of estimating an energy response function, the method comprising:
emitting multiple polychromatic X-rays having different energy levels to an object;
calculating, by a processor, a spectrum measurement value of a detector by counting photons from the multiple polychromatic X-rays that pass through the object;
initializing a tube voltage of an X-ray tube for the multiple polychromatic X-rays and calculating, by the processor, a real X-ray spectrum with respect to the initialized tube voltage; and
estimating, by the processor, an energy response function based on the calculated spectrum measurement value of the detector.

11. The method of claim 10, wherein the calculating comprises measuring of the spectrum of the detector by performing a threshold scan with respect to the emitted multiple polychromatic X-rays.

12. The method of claim 10, wherein the calculating comprises measuring of the spectrum of the detector by sequentially changing an energy threshold with respect to the tube voltage set for the X-ray tube.

13. The method of claim 10, further comprising:
estimating the energy response function by an inverse estimation based on the real X-ray spectrum and the spectrum measurement value of the detector.

14. At least one computer readable medium comprising computer readable instructions that control at least one processor to implement a method, comprising:
emitting multiple polychromatic X-rays having different energy levels to an object;
calculating a spectrum measurement value of a detector by counting photons from the multiple polychromatic X-rays that pass through the object;
initializing a tube voltage of an X-ray tube for the multiple polychromatic X-rays and calculating a real X-ray spectrum with respect to the initialized tube voltage; and
estimating an energy response function based on the calculated spectrum measurement value of the detector.

15. The at least one computer readable medium of claim 14 implementing the method, wherein the calculating comprises measuring of the spectrum of the detector by performing a threshold scan with respect to the emitted multiple polychromatic X-rays.

16. The at least one computer readable medium of claim 14 implementing the method, wherein the calculating comprises measuring of the spectrum of the detector by sequentially changing an energy threshold with respect to the tube voltage set for the X-ray tube.

17. The at least one computer readable medium of claim 14 implementing the method, further comprising:
estimating the energy response function by an inverse estimation based on the real X-ray spectrum and the spectrum measurement value of the detector
